(19) United States
(12) Patent Application Publication
(10) Pub. No.: US 2021/0152651 A1
(43) Pub. Date: May 20, 2021

(54) METHOD FOR THE EVENT-CONTROLLED RETRIEVAL OF PROCESS DATA

(71) Applicants: Hubertus Hohl, Unterhaching (DE); Markus Sauer, München (DE)

(72) Inventors: Hubertus Hohl, Unterhaching (DE); Markus Sauer, München (DE)

(21) Appl. No.: 17/041,887

(22) PCT Filed: Feb. 15, 2019
(86) PCT No.: PCT/EP2019/053834

§ 371 Date: Sep. 25, 2020

(30) Foreign Application Priority Data
Mar. 26, 2018 (DE) 10 2018 204 558.5

(51) Int. Cl. H04L 29/08

(52) U.S. Cl. CPC H04L 67/26; H04L 67/2809; H04L 67/12

(57) ABSTRACT

The method according to the invention provides for event-controlled retrieval of process data by using a publish-subscribe service, for example MQTT, and with the participation of a message broker. For the retrieval according to the invention, retrieval of a multiplicity of process data reserved in a distributed manner in the form of response messages can be carried out by a single request message. Advantageously, it permits the method according to the invention to implement a dynamic data request, in which new response messages to a request message are transmitted when changes in the process data provided or stored result. A data retrieval component transmitting the request message needs neither details about the request modalities of data-providing components nor knowledge or direct references to currently available data-providing components. The method thus permits dynamic, event-controlled retrieval of object data in a decentralised IoT environment, in which heterogenous system components produce, store and process data in different ways.

This application is the National Stage of International Application No. PCT/EP2019/053834, filed Feb. 15, 2019, which claims the benefit of German Patent Application No. DE 10 2018 204 558.5, filed Mar. 26, 2018. The entire contents of these documents are hereby incorporated herein by reference.

### BACKGROUND

The present embodiments relate to event-controlled retrieval of process data.

The present disclosure relates generally to retrieval of process data in process installations and process control systems (e.g., for real-time performance monitoring and analysis of real-time data generated by process installations and process control systems). Such retrieval of process data is used, for example, in the field of industrial automation engineering, for production machines or machine tools, for diagnosis and service support systems, and for operation and maintenance of complex components, devices and systems (e.g., industrial or medical installations).

Present-day industrial work environments are characterized by decentralized data management in various, distributed system components (e.g., in cloud systems or edge computing systems). Data-producing system components (e.g., field devices) typically transmit their process data to data provision components provided for the storage and later retrieval of data. These data provision components include decentralized databases, which are also referred to as a cloud database or edge database among experts.

Data retrieval components (e.g., for analyzing the process data) that retrieve and evaluate process data from individual specific data provision components are used.

Such distribution between data provision components for the decentralized storage of process data and data retrieval components for the decentralized accessing of process data has already found widespread use in modern industrial work environments on account of corresponding advantages (e.g., in terms of failsafety, scalability, etc.). However, numerous disadvantages of this distributed process data management currently practiced also come to the fore.

As the speed of development of individual system components advances, planning and integration of these system components is no longer possible based on the current known implementation of individual system components, especially since a growing scope of functions in individual system components also hampers the integration and cooperation thereof. For example, in a scenario having dynamic peer-to-peer scenarios between system components, which is also planned as “Industry 4.0”, known mechanisms reach their limits.

A growing problem of currently used methods for retrieving process data is that the data retrieval component often requires frequent retrieval of multiple separate and uncoordinated data provision components. A single query for retrieving separately managed process data from different data provision components is currently not possible. Instead, separate queries are to be made, and numerous responses to the individual queries are to be combined.

Another disadvantage is a current limitation that an initiative for the data query is to come from the data retrieval component and cannot be triggered, for example, by a specific event (e.g., the presence of a specific value in a process datum or a change in specific process data).

Such methods for retrieving process data are limited by the fact that a respective query interface (e.g., query application programming interface, or query API) of every queried data provision component is to be implemented in the data retrieval component in order to be able to retrieve process data from a respective different data provision component. In view of many diverse variants of data provision components (e.g., relational, object-oriented, object-relational databases) or else in the form of component-internal storage of process data with a proprietary query interface; a standard data query across different data provision components is difficult or even impossible.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method that allows event-controlled retrieval of process data in a number of data provision components regardless of a query interface thereof is provided.

The method according to the present embodiments provides for event-controlled retrieval of process data, which is set up for exchanging messages with a publication/subscription service (e.g., a publish/subscribe service among experts) with the involvement of a message broker. Such a message broker forwards a message published with a topic or associating subject (e.g., request or response messages) to at least one component with a subscription for this associating subject. The method includes the following method acts. a) A data retrieval component generates a request message, or “query”, that contains not only a query syntax but also an associating subject. The request message is transmitted to the message broker and published by the message broker. b) The data retrieval component sets up a subscription for response messages, or “retrieve” messages, containing the identical associating subject of the request message. This subscription is either set up explicitly or may have been set up by the publication/subscription service automatically based on he previously sent request message. c) At least one data provision component receives a request message published with the associating subject. Following an optional check to determine whether this request message is resolvable by the data provision component (e.g., handlable and able to be responded to by the data provision component), a publication/subscription service for messages containing the associating subject of the request message is set up. If the request message is not resolvable by a data provision component, then, optionally, no further action is taken by the data provision component. d) In response to a request message that is received and resolvable by the data provision component, the request is then handled, which involves the data provision component providing data requested by the request message. A response message, or “retrieve” message, that contains the provided data is then generated. The response message is provided with the same associating subject as was used for the request message. The response message is then transmitted to the message broker, and the request message is published by the message broker.

The present embodiments render a retrieval of process data event-controlled by using the advantages of the publication/subscription service, which triggers a provision of data in the event of a definable change, without the data retrieval component needing to initiate the provision. After a request message is sent, the data retrieval component remains ready to receive any number of response messages. These may be sent by data provision components at any times, or may not be sent. Data provision components may be added, replaced, or removed at will without needing to change the structure of the retrieval of process data according to the present embodiments. The method according to the present embodiments therefore allows event-controlled dynamic data querying to be performed that involves new response messages being sent whenever changes in the provided or stored process data arise. At system level, this provides a distributed, stationary request channel.

The present embodiments retrieve process data in a number of data provision components by using the advantages of the publication/subscription service, which provides a departure from formerly necessary single requests by the data retrieval component toward an advantageous subscription by the data retrieval component. For the retrieval according to the present embodiments, a single request message may retrieve a multiplicity of process data held in distributed fashion.

The present embodiments allow retrieval of process data in a number of data provision components regardless of the query interface thereof by virtue of the data retrieval being effected by a request message in which the request is organized at pure data level. A data retrieval component requires neither details about the request methods of the data provision components nor knowledge of or direct references to currently available data provision components. Standard retrieval of process data across different data provision components is provided by the standard format of the request message and the response message by virtue of the data provision components converting the standard request into internal database query languages and database schemes.

### BRIEF DESCRIPTION OF THE DRAWING

FIG. 1 shows a schematic diagram that illustrates an exemplary exchange of messages between components operating according to the present embodiments that accompanies the method according to the present embodiments.

### DETAILED DESCRIPTION

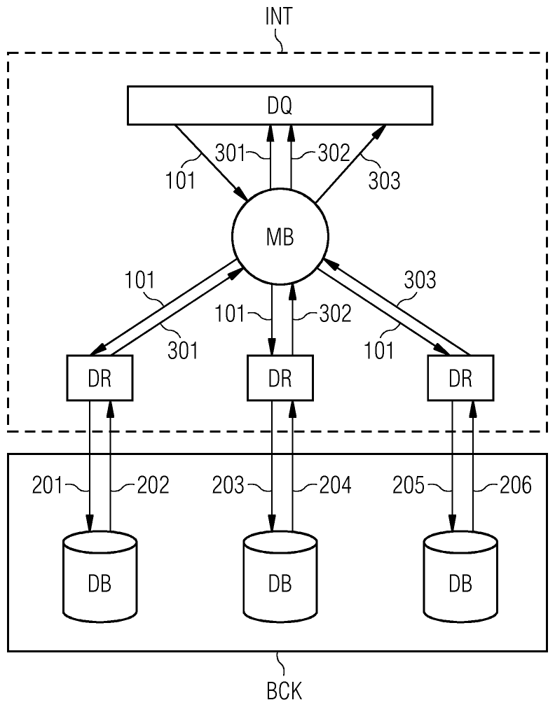

FIG. 1 shows an exemplary integration layer INT in which multiple functional components MB, DQ, DR communicate in wireless and/or wired fashion. The integration layer INT depicted using a dashed box is shown in isolation from a backend layer BCK, depicted by a box drawn using a solid line, which primarily consists of the process data memory DB for decentralized data management and data processing (e.g., in the spirit of cloud computing). The isolation merely serves the purpose of description and is otherwise insignificant to the present embodiments.

Within the integration layer INT, a data retrieval component DQ is at least temporarily communicatively connected to a message broker MB. Further, at least one (e.g., three shown in FIG. 1) data provision component DR is at least temporarily communicatively connected to the message broker MB.

The message broker MB serves as a mediator for messages exchanged between the data retrieval component DQ and the data provision components DR, also including functional components (not depicted in the drawing) that form a hybrid form (e.g., act both as data provision components DR and as data retrieval component DQ).

In the message broker MB or optionally also in the data retrieval component DQ and the data provision components DR, there is an event-controlled publication/subscription service, or publish/subscribe service, set up. According to this, message distribution takes place from a publishing component (e.g., publisher) to one or more subscribing components (e.g., subscribers). Publication of or subscription to messages takes place based on an associating subject or topic. By indicating an associating subject, a subscribing client provides notification of the messages in which there is an interest or of the associating subject for which a subscription is taken out. In the simplest mode of operation, the message broker, on receiving a subject from a publishing component, is merely to check whether there is a subscriber for the respective subject. If so, the data is forwarded to the subscriber or subscribers; otherwise the data is discarded.

The publication/subscription service may be provided using the message queueing telemetry transport (MQTT) protocol or a variant thereof. MQTT is an event-controlled publish/subscribe protocol for message exchange between devices. The protocol MQTT is data-agnostic (e.g., not defined for a specific data format). It is possible for both raw data relating to a single measured quantity and complex data structures to be transmitted.

Data transmission by MQTT provides a high level of reliability that is employed, for example, for sensor networks, for machine-to-machine (M2M) communication, M2M and for the “Internet of Things”. In the case of the Internet of Things (IoT), the communicating devices involved are normally always online and communicate with one another on an ongoing basis.

According to alternative configurations, the publication/subscription service is provided using the data distribution service (DDS) protocol or using the web application messaging protocol (WAMP), or using a variant or development of these protocols.

In the present configuration, the individual components DQ, DR are connected to the central message broker MB by using the MQTT protocol. The message broker MB serves as an information mediator between the data retrieval component DQ and the data provision components DR. A component DQ, DR may publish or subscribe to specific information using special message channels. The individual message channels are denoted using the associating subject or topic. The message channels are able to be organized in tree form, in accordance with a plurality of structured subject entries.

The method according to the present embodiments is explained below with reference to the drawing by illustrating an exchange of messages between the components DQ, DR and the central message broker MB.

A data retrieval component DQ generates a request to retrieve process data. In response to this, a request message 101, or “query”, is generated. The request message 101 is delivered to the message broker MB, where the request message 101 is published by using the publication/subscription service. This publication is depicted in the drawing by a request message 101 forwarded from the message broker MB to at least one (e.g., all, as shown in FIG. 1) data provision component DR.

The query syntax of the request message 101, which specifies the expected data for the request, is formulated in a database-agnostic manner, for example, in the form:

QUERY (Message Token)
{

objectType: CuttingTool,
filterConditions:
{
and:
[

[remainingToolLife, filterOp.lessThan(42)],
[toolType, filterOp.equals(solid drill)],
[associatedMachine, filterOp.equals(Heller 01)],

]

},
take: 77,
orderBy: [[remainingToolLife, asc], [name, asc]]
}

The depicted request message 101 is uniquely identified by the exemplary associating subject “Message Token”. This character string “Message Token” is used for associating later response messages with this request message 101.

The exemplary query syntax above retrieves the first 77 object data records for objects of the “CuttingTool” type, which are solid drills, have a “remainingToolLife” of less than 42 minutes (e.g., specified in dimensionless fashion), and are associated with the CNC machine “Heller 01” by the argument of the search instruction, “associatedMachine”. The results are intended to be returned by the instruction

orderBy: [remainingToolLife, asc], [name, asc]]

in ascending order of remaining tool life and name of the cutting tool.

In a further act, a subscription for response messages that contain the same associating subject (e.g., “Message Token”) as the request message 101 is set up in the publication/subscription service. The subscription is set up either by the data retrieval component DQ or by the message broker MB.

In the exemplary embodiment, a subscription to receive response messages of the MQTT type “RETRIEVE” that contain the associating subject “Message Token” is set up. The subscription is either set up explicitly (e.g., by a specific request to the publication/subscription service), or the subscription may also be set up by the publication/subscription service implicitly or automatically based on the previously sent request message 101.

All of the data provision components DR have this request message 101 delivered to the data provision components DR by the message broker MB. In order to provide delivery of the request messages to data provision components DR, the message broker MB or the data provision components DR has/have previously set up a generic subscription (e.g., a subscription for request messages with any associating subject).

Following reception of the request message 101 by a data provision component DR, the data provision component DR checks whether the request transmitted using the request message 101 may be “resolved” (e.g., is handleable and able to be responded to by the data provision component DR). Such a check involves a search in process data memories DB, which, depending on the embodiment, are configured as nonvolatile or volatile memories in computer systems, as system-internal databases or system-externally accessible databases, for suitable results for the request. By way of example, the object type of the request, “CuttingTool” in the example above, is checked first.

If a data provision component DR (e.g., managing one or more process data memories DB) does not hold any data for this object type, no response message is generated. Otherwise, the data provision component DR translates the request in the request message 101, which is made using a generic (e.g., database-agnostic) query syntax, into a respective database-specific database query 201, 203, 205 by using the specific database scheme and executes the database query. By way of example, a first database-specific database query 201 is configured in structured query language (SQL) for querying a relational database.

The query syntax is interpreted and handled asynchronously and independently on every single data provision component DR in cooperation with one or more process data memories DB associated therewith.

The data provision components DR used in accordance with the present embodiments are not limited to backend systems for cloud computing, edge computing, persistent systems. The method is expandable to any variants of data provision components DR or process data memories DB. As such, for example, specific runtime data or in-memory data may be requested from process devices. Further, sensor measurements may be actuated in specifically distributed fashion, and the measurement data therefrom may be returned.

In other words, the retrieval of process data of the present embodiments allows not only conventional “retrieval” from data-storing components (e.g., database systems), but rather, generally, retrieval from data provision components DR, which may also generate corresponding process data (e.g., dynamically in real time). The same retrieval method may be used irrespective of the type of the data provision components DR.

The method according to the present embodiments therefore allows transparent use of any data provision components DR in combination with arbitrarily associated process data memories DB. By way of example, a data retrieval from a sensor as data provision component DR takes place (e.g., with respect to the retrieval method and with respect to messages exchanged) in a same fashion as a data retrieval from a complex cloud database.

A respective search result 202, 204, 206 returned from the process data memory DB to the data provision component DR thereof is handled by the applicable data provision component DR and published using the publication/subscription service in a response message 301, 302, 303 having a “RETRIEVE” MQTT type. The response message is conveyed to the data retrieval component DQ via the message broker MB based on the associating subject “Message Token”. The object data relating to the requested object type are transmitted in the content of the response messages 301, 302, 303. The object data in this instance are composed, as shown below, from the data stored internally in the database, which are converted into a standard object notation. A response message 301 has the following syntax, for example:

RETRIEVE (Message Token)
[

{

objectId: da44c4a6-e8a3-4fdd-86fb-8f3eb477dcc4
objectType: CuttingTool,
name: B20HSK63001,
toolType: solid drill,
remainingToolLife: 10,
associatedMachine: Heller 01,
...

},

{

objectId: cbce409b-b865-4fd1-9138-805af8036487
objectType: CuttingTool,
name: B20HSK63003,
toolType: solid drill,
remainingToolLife: 10,
associatedMachine: Heller 01,

...

},
...

In line with the request message 101, the exemplary response message 301 above transmits multiple object data records (for reasons of clarity, only two object data records are depicted above) for objects of the “CuttingTool” type, which are solid drills, have a “remainingToolLife” of less than 42 minutes (e.g., 10 minutes) and are associated with the CNC machine “Heller 01” by the argument of the search instruction (e.g., “associatedMachine”). The results are returned in ascending order of remaining tool life and name of the cutting tool in accordance with the requirements for the request message 101. Stated in general terms, the query syntax of the request message 101 is structure-forming for the provision of the process data in the response message 301.

Like the accompanying request message 101, the depicted response message 301 uses the associating subject “Message Token” to associate the response message 301 with the request message 101.

Advantages of the method according to the present embodiments are compared below against the client/server-based methods used to date for statically retrieving separately managed data.

Whereas client/server-based methods for statically retrieving separately managed data that are known in the prior art necessitated a specific request by a data-retrieving client to multiple individual data-providing servers, the retrieval of process data of the present embodiments takes place in decentralized fashion, in a distributed manner, and purely at data level. The data retrieval component DQ requires no kind of knowledge about the data provision components DR currently available in the system. These may be added to the system or removed from the system at will. Separate and uncoordinated object data from different backend systems BCK may be combined dynamically without needing to have internal knowledge about the backend systems BCK.

Whereas known client/server-based methods for statically retrieving separately managed data required multiple individual data queries that were only ever handled by the directly addressed data-providing component and completed with a maximum of one response, the retrieval of process data of the present embodiments requires just a single query for retrieving separately managed data from different data provision components DR. It is solely the responsibility of the data retrieval component DQ how long the data retrieval component DQ waits for response messages (e.g., by a timeout) or how many response messages the data retrieval component DQ can expect. After sending a request message, the data retrieval component DQ remains fundamentally ready to receive any number of response messages. These may be sent by data provision components DR at any time or may not be sent at all. It is thus possible to perform event-controlled dynamic data querying that involves new response messages being sent whenever changes in the provided or stored data arise. At system level, this provides a distributed, stationary request channel. The retrieval of process data of the present embodiments is not addressed to specific components directly, but rather is directed to all available components that have set up an applicable subscription.

According to the known client/server-based methods for statically retrieving separately managed data, a specific query interface of a respective data-providing server had to be implemented on the data-retrieving client in order to be able to retrieve data from the server. Different data-providing servers usually used different query interfaces (e.g., HTTP-based REST APIs), which rendered a standard data query across different data-providing servers difficult or even impossible. For example, for every desired data fragment, an associated data-providing server had to be known in advance. A general query concerning a data fragment was not possible. By contrast, the retrieval of process data of the present embodiments allows a standard data query across different data provision components DR. Aided by a standard format for request and response messages, the conversion into internal database query languages and database schemes and handling of the request message takes place in the data provision component DR instead of in the data retrieval component DQ, which allows a standard data query across different data provision components DR without additional complexity. The retrieval of process data of the present embodiments allows simple integration into heterogeneous edge/cloud environments with different database systems.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1.-9. (canceled)

10. A method for event-controlled retrieval of process data using a message broker set up for a publication/subscription service, the method comprising:
generating, by a data retrieval component, a request message that contains an associating subject and transmitting the request message to the message broker;
publishing, by the message broker, the request message;
setting up, by the data retrieval component, the message broker, or the data retrieval component and the message broker, a subscription for response messages to be received from a data provision component, the response messages containing the associating subject of the request message;
receiving, by the data provision component, the request message published with the associating subject and setting up a publication/subscription service for messages that contain the associating subject of the request message;
providing, by the data provision component, process data requested by the request message;
generating a response message containing the provided process data and the associating subject of the request message;
transmitting the response message to the message broker; and
conveying a response message published using the publication/subscription service to the data retrieval component via the message broker (MB).

11. The method of claim 10, wherein a query syntax contained in the request message is formulated in a database-agnostic manner.

12. The method of claim 11, wherein the query syntax of the request message is structure-forming for the provision of the process data in the response message.

13. The method of claim 10, wherein the publication/subscription service is implemented using a message queueing telemetry transport protocol.

14. The method of claim 10, wherein the publication/subscription service is implemented using a data distribution service protocol.

15. The method of claim 10, wherein the publication/subscription service is implemented using a web application messaging protocol.

16. The method of claim 10, further comprising requesting, by the data provision component, the process data from a process data memory by the data provision component.

17. The method of claim 16, wherein the process data memory is in the form of:
a nonvolatile memory in computer systems;
a volatile memory in computer systems;
a computer-system-internal database;
a computer-system-external database;
an externally accessible database; or
any combination thereof.

18. The method of claim 11, wherein the publication/subscription service is implemented using a message queueing telemetry transport protocol.

19. The method of claim 12, wherein the publication/subscription service is implemented using a message queueing telemetry transport protocol.

20. The method of claim 11, wherein the publication/subscription service is implemented using a data distribution service protocol.

21. The method of claim 12, wherein the publication/subscription service is implemented using a data distribution service protocol.

22. The method of claim 11, wherein the publication/subscription service is implemented using a web application messaging protocol.

23. The method of claim 12, wherein the publication/subscription service is implemented using a web application messaging protocol.

24. The method of claim 12, further comprising requesting, by the data provision component, the process data from a process data memory by the data provision component.

25. The method of claim 24, wherein the process data memory is in the form of:
a nonvolatile memory in computer systems;
a volatile memory in computer systems;
a computer-system-internal database;
a computer-system-external database;
an externally accessible database; or
any combination thereof.
